(19) United States
(12) Patent Application Publication
(10) Pub. No.: US 2009/0012899 A1
(43) Pub. Date: Jan. 8, 2009

(54) SYSTEMS AND METHODS FOR GENERATING AND MANAGING A LINKED DEPOSIT-ONLY ACCOUNT IDENTIFIER

(76) Inventor: Mark Friesen, Portland, OR (US)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/168,050

(22) Filed: Jul. 3, 2008

Related U.S. Application Data
(60) Provisional application No. 60/958,558, filed on Jul. 6, 2007.

(51) Int. Cl. G06Q 40/00

(52) U.S. Cl. 705/44; 705/35

(57) ABSTRACT

Embodiments relate to systems and methods for generating and managing a deposit-only account identifier that can be portably linked to one or more transaction accounts, at the account holder's discretion. A deposit-only account identifier can be a virtual identifier, such as a temporary or permanent account number. The account holder can publish the virtual identifier to desired persons, financial institutions, or other parties to permit those entities to transmit funds to the deposit-only account. The account holder can move received funds to one or more linked transaction accounts, such as bank checking accounts, money market accounts, or others. Details regarding the underlying account(s) such as geographic location, currency, balances or other information can be retained in confidence, visible only to the account holder. Received funds can be distributed to underlying accounts according to criteria such as the currency or amount of the received funds, time of receipt, or other rules.

### CROSS-REFERENCE TO RELATED APPLICATIONS

The subject matter of this application is related to the subject matter of U.S. Provisional Application No. 60/958,558, filed Jul. 6, 2007, entitled “Virtual Deposit-Only Account Numbering,” which application is incorporated herein by reference, and from which application priority is claimed.

### FIELD

The present teachings relate to systems and methods for generating and managing a linked deposit-only account identifier, and more particularly to platforms and techniques for portably linking a deposit-only account identifier to one or more underlying transaction account selected by the account holder.

### BACKGROUND OF RELATED ART

The proliferation of networked payment platforms on the Internet and other networks has increased transaction flexibility for consumers, merchants, and financial institutions alike. As consumers transact more of their business online, the need to provide security mechanisms to protect sensitive information such as checking account numbers, credit card numbers, and other account identifiers or other data has increased.

While security techniques exist to encrypt account numbers, social security numbers, and other confidential data, account holders who wish to move funds, make purchases, or perform other transactions using those identifiers must still enter and transmit that information across the Internet or other network. Those account or other data can therefore still be susceptible to interception at different points in the transaction processing cycle, and if hacked, that data can be used to effect fraudulent or unauthorized transactions against the subject account. This is possible because common account types such as credit card, checking, brokerage, or other accounts are often or usually configured to permit both incoming or deposit transactions, as well as outgoing or withdrawal transactions. Deposit or withdrawal transactions against many of those accounts can be initiated by third parties without the account holder's knowledge or consent.

Partly in response to these concerns, banks and other financial institutions have been encouraged to provide customers with limited-access account identifiers, and particularly account identifiers that are configured to be used only to provide a method to deposit funds into the account. A deposit-only account identifier is associated with an account or stored-value product and is used with any form of payment or settlement system, but only allows deposits into the account. Any debit type transaction using the deposit-only account identifier would be considered invalid and rejected.

Many banks and other financial institutions have, however, been slow to deploy deposit-only account identifiers on behalf of their customers, and therefore that type of service has had little if any availability in the marketplace. Moreover, even if deployed, deposit-only account identifiers as conventionally proposed are strictly tied to the bank or other financial institution supporting a specific account at financial institution that has assign the account identifier and maintains the account. That being the case, it is impossible for the user to select other accounts to link to the deposit-only account identifier. There are additional disadvantages that result from captive deposit-only account identifiers, including that if an account holder wishes to change banks or other providers, the account holder must terminate the deposit-only account number and start a new account at another bank with a new deposit-only account identifier, and notify all interested parties of the change in account. It may be desirable to provide methods and systems for generating and managing a linked deposit-only account identifier, in which the deposit-only account identifier can be portably linked to any other underlying account at the user's election.

### DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an overall system for generating and managing a linked deposit-only account identifier, according to various embodiments;

FIG. 2 illustrates an overall system for generating and managing a linked deposit-only account identifier in further regards, according to various embodiments;

FIG. 3 illustrates an illustrative configuration of a hardware platform that can be used in systems and methods for generating and managing a linked deposit-only account identifier, according to various embodiments; and

FIG. 4 illustrates a flowchart of account and transaction processing for a linked deposit-only account identifier, according to various embodiments.

### DESCRIPTION OF EMBODIMENTS

Embodiments of the present teachings relate to systems and methods for generating and managing a linked deposit-only account identifier. More particularly, embodiments related to platforms and techniques for generating, configuring, linking and managing a linked deposit-only account identifier in which the underlying transaction account(s) to which the deposit-only account identifier is portably linked can be selected, updated and managed by the account holder at their discretion. In embodiments, the deposit-only account identifier can consist of a virtual identifier, such as a temporary or permanent account-like number, user name, or other tag or sufficiently unique method. In embodiments, details related to the deposit-only account identifier as well as the underlying transaction account or accounts can be maintained in confidence, so that parties transmitting funds to the underlying account are not aware of the geographic location, account holder, designated currency, current balances or limits, or other information associated with those accounts. These and other embodiments described herein address the various noted shortcomings in known electronic transaction technology, and provide a user or network operator with enhanced flexibility and convenience in the management of deposit-only account identifiers.

Reference will now be made in detail to exemplary embodiments of the present teachings, which are illustrated in the accompanying drawings. Where possible the same reference numbers will be used throughout the drawings to refer to the same or like parts.

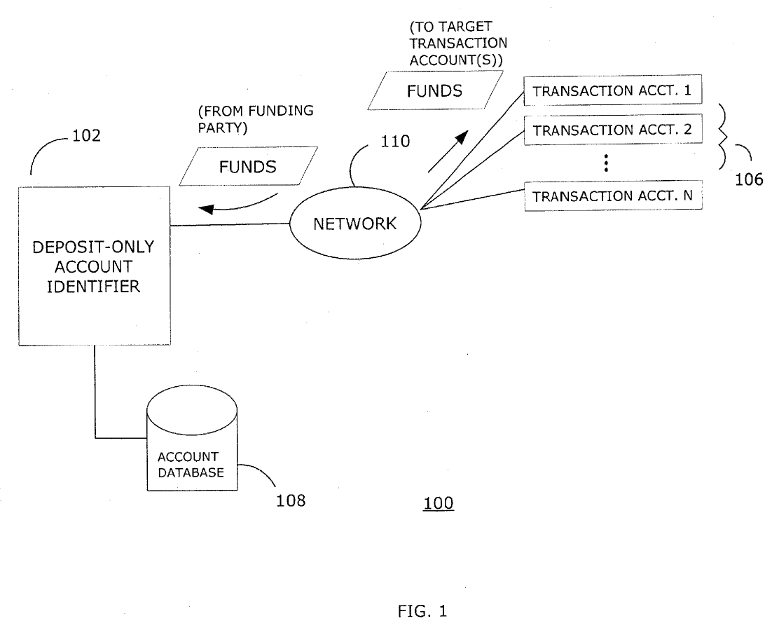

FIG. 1 illustrates an overall network system 100, consistent with systems and methods for generating and managing a linked deposit-only account identifier according to various embodiments of the present teachings. In embodiments as shown, an overall system 100 can include a deposit-only account identifier 102 that communicates with a set of transaction accounts 106 via one or more networks 110. Deposit-only account identifier 102 can consist of an account identifier hosted by a server or other supporting hardware, software, and logic. Deposit-only account identifier 102 can be a temporary or permanent account-like number, account name, user or account holder name, or other designation or identifier. Deposit-only account identifier 102 can be initiated, configured, and managed by an individual or other account holder, or in embodiments by users authorized by the account holder. Deposit-only account identifier 102 can be hosted by on a Web site, and/or at a physical site. In embodiments deposit-only account identifier 102 can be accessed via telephone, or other electronic connections. In embodiments, one or more networks 110 can be or include the Internet, or other public or private networks.

In embodiments in one regard, the account holder can publish, transmit or circulate the virtual deposit-only account identifier 102 to parties the account holder wishes to be able to transmit funds to accounts linked to that virtual identifier. The deposit-only account identifier 102 can be supplied to those parties by transmitting that identifier via the Internet, for instance via entering that data via a Web site, by email, or other channels. The account holder can choose to publish the deposit-only account identifier, for instance, to financial institutions such as banks, brokerages, or credit card companies, as well as to individuals or other entities. The funds transacted via deposit-only account identifier 102 can comprise any type of currency, money, or other types or units of value.

Parties who receive deposit-only account identifier 102 can transmit funds to underlying accounts linked to deposit-only account identifier 102 through any electronic or manual payment technique. In terms of electronic funds movements, parties transmitting funds to deposit-only account identifier 102 can transmit funds via an Automated Clearing House (ACH) transaction, an electronic debit transaction, a payment via a credit payment network such as the VISA™ or MasterCard™ networks, by direct bank wire, or other transaction channels, networks, or mechanisms. In embodiments, payments can be received in deposit-only account identifier 102 by paper check or money or cash deposits, or other payment instruments or techniques. For example deposit-only account identifier 102 can likewise receive funds originating from a stored-value card.

In embodiments as shown, deposit-only account identifier 102 can be linked to an underlying set of linked transaction accounts 106. The set of linked transaction accounts 106 can contain one or more accounts configured to both receive and transmit funds. Set of linked transaction accounts 106 can contain any one or more of any type of account, including a bank checking account, a money market account, brokerage account, a credit card account, a stored value account, a prepaid telephone usage account, a merchant credit account, or other accounts. Set of linked transaction accounts 106 can in embodiments include accounts generated or maintained by entities other than financial or depository institutions. In general, the individual accounts of set of linked transaction accounts 106 can be configured to both receive and transmit funds. In embodiments, the set of linked transaction accounts 106 can however also include other deposit-only account identifiers, or other types of accounts. In embodiments, any one or more of the accounts of set of linked transaction accounts 106 can be accessible by third parties to initiate deposit or withdrawal transactions, or others. In embodiments, the account holder can retain full discretion to include, delete, configure, or otherwise manage the set of linked transaction accounts 106, independently of the financial institution or other entity hosting those accounts. Deposit-only account identifier 102 can therefore be made to be fully portable to re-configure with a desired set of underlying set of linked transaction accounts 106 at any time of the account holder's choosing.

Deposit-only account identifier 102 can be configured by the account holder to distributed all or a portion of incoming funds from a transmitting or originating party to any one or more of set of linked transaction accounts 106. In embodiments, the account holder can access and manage the routing or distribution of received funds to set of linked transaction accounts 106 via a Web browser, or other Web application or service. The funds transfer to the selected account or accounts in set of linked transaction accounts 106 can be settled or reconciled using any known settlement mechanism. In embodiments, the transmission of funds from the transmitting party to any of the underlying set of linked transaction accounts 106 can occur over international borders, or can be conducted on a domestic basis in one country.

It may be noted that according to embodiments in one regard, details related to deposit-only account identifier 102 and/or set of linked transaction accounts 106 can be maintained in privacy for the account holder. For example, the parties transmitting funds to deposit-only account identifier 102 may not have access to or be made aware of the identity of the account holder, the designated currency, the geographic location, the account balance or any account limits, or other details associated with deposit-only account identifier 102 and/or the set of linked transaction accounts 106. However, in embodiments in further regards, the company or other entity supporting or operating deposit-only account identifier 102 can still maintain all regulatory and compliance data necessary to supply to local authorities in locations where deposit-only account identifier 102 or its infrastructure is located, as appropriate.

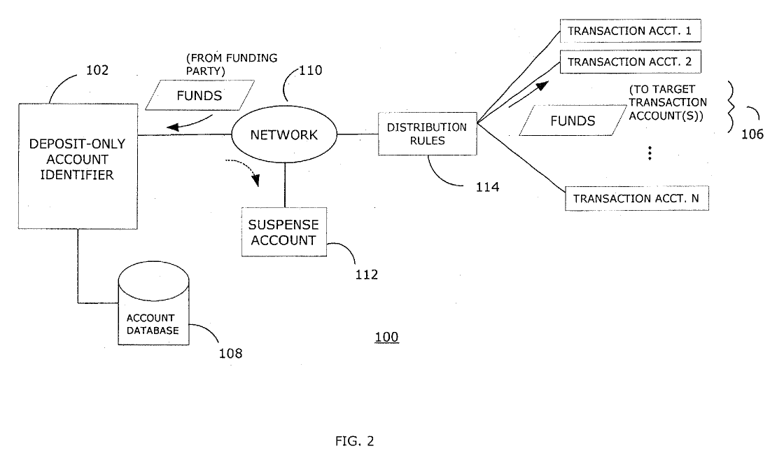

In embodiments as for example shown in FIG. 2, deposit-only account identifier 102 can be provided with additional resources or features to assist in managing that account. In embodiments as shown, a suspense account 112 can be associated with deposit-only account identifier 102 to which funds can be diverted when no valid or active account exists in set of linked transaction accounts 106, or at other times. In embodiments, suspense account 112 can be hosted by the same entity or at the same location that hosts deposit-account only identifier 102, or can be hosted remotely via network 110, as illustratively shown.

Moreover, in embodiments as shown deposit-only account identifier 102 can communicate with a set of distribution rules 114 that govern the distribution of funds from deposit-only account identifier 102 to set of linked transaction accounts 106. For example, the account holder can select rules which operate to route funds received in one currency to an account in set of linked transaction accounts 106 that is denominated in the same currency. For another example, the account holder can select rules that cause funds below a defined amount to be distributed to one account, while funds above that amount are distributed to another account. For yet another example, the account holder can select rules that cause funds to be distributed to different target accounts, depending on the date or time received. Other rules or logic can be embedded in distribution rules 114.

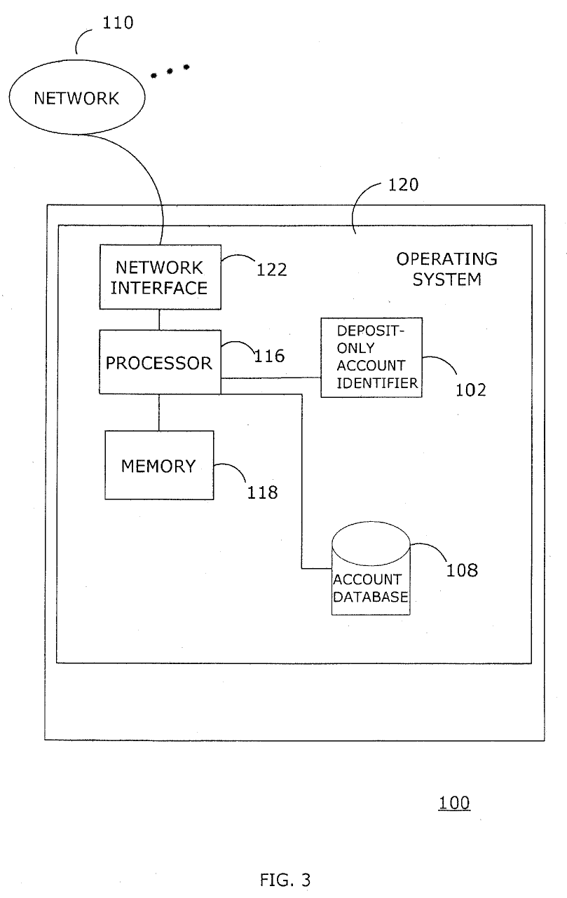

FIG. 3 illustrates an exemplary diagram of hardware and other resources that can be incorporated in a system 100 configured to support deposit-only account identifier 102 and other resources, according to embodiments. In embodiments as shown, system 100 can comprise hardware resources including a processor 116 communicating with memory 118, such as electronic random access memory, operating under control of or in conjunction with operating system 120. Operating system 120 can be, for example, a distribution of the Linux™ operating system, the Windows™ family of operating systems, or other operating system or platform. Processor 116 also communicates with account database 108, such as a database stored on a local hard drive. Processor 116 further communicates with network interface 122, such as an Ethernet or wireless data connection, which in turn communicates with one or more networks 110, such as the Internet or other public or private networks. Other configurations of system 100, associated network connections, and other hardware and software resources are possible.

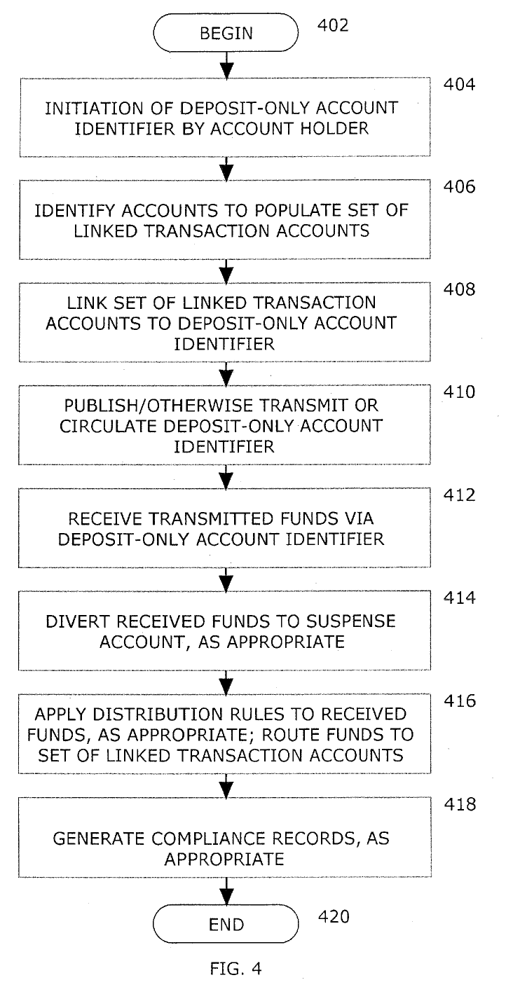

FIG. 4 illustrates a flow diagram of overall deposit-only account processing, according to embodiments of the present teachings. In step 402, processing can begin. In step 404, an account holder can initiate and configure a deposit-only account identifier 102, for example via a Web browser or other software. In step 406, the account holder can identify one or more accounts to populate set of linked transaction accounts 106. In step 408, deposit-only account identifier 102 can be linked to set of linked transaction accounts 106, for example by registering the individual account numbers or other identifiers, locations, financial institutions, or other data in account database 108.

In step 410, the virtual identifier 104 associated with deposit-only account identifier 102 can be published, circulated or transmitted to parties selected by the account holder. In step 412, a transmission of funds can be received in deposit-only account identifier 102, for example from an individual, a company, or other entity to whom deposit-only account identifier 102 has been published or communicated. In step 414, the received funds can be diverted to suspense account 112 if no active or valid target transaction account is available. In step 416, distribution rules 114 (if used) can be applied to funds received in deposit-only account identifier 102, as appropriate, and funds can transferred to a target account or accounts in set of linked transaction accounts 106. Distribution rules 114 if used can route funds to individual accounts in set of linked transaction accounts 106, for example, according to type of currency, date or time received, identity of sender, geographic location of sender, size of funds, or other rules or criteria, as appropriate. In cases where suspense account 112 is not necessary and distribution rules 114 are not employed, funds can be transmitted directly to set of linked transaction accounts 106. In step 420, compliance records for deposit-only account identifier 102 and/or set of linked transaction accounts 106 can be generated, as appropriate. In step 422, processing can repeat, return to a prior processing point, jump to a further processing point, or end.

The foregoing description is illustrative, and variations in configuration and implementation may occur to persons skilled in the art. For example, while embodiments have been described in which one account holder or authorized user initiates and/or manages an account, in embodiments multiple account holders or authorized users can initiate, access, and/or manage a linked deposit-only account identifier 102 according to the present teachings. For further example, while certain embodiments have been described in which transactions transmitting funds into the deposit-only account identifier 102 and/or transactions involving movement of funds to or from set of linked transaction accounts 106 take place across international borders, in embodiments any one or more of those transactions can occur domestically within one country or other jurisdiction. Further, while embodiments have been described in which incoming funds are received in set of linked transaction accounts 106, in embodiments the account holder can receive the funds in the form of cash, with no underlying set of transaction accounts by way of an automatically generated suspense account when funds are received.

For another example, while embodiments have been described in which one account holder maintains one deposit-only account identifier 102, in embodiments an account holder can maintain multiple instances of deposit-only account identifiers 102. In cases where multiple deposit-only account identifiers are established, in embodiments those account identifiers can be configured to communicate funds between themselves or otherwise be aggregated, under control of the account holder. For yet further example, while embodiments have been described in which information related to deposit-only account identifier 102 is stored to a single account database 108, in embodiments information related to deposit-only account identifier 102, set of linked transaction accounts 106, and/or other information can be stored to multiple databases or data stores. Other resources described as singular or integrated can in embodiments be plural or distributed, and resources described as multiple or distributed can in embodiments be combined. The scope of the present teachings is accordingly intended to be limited only by the following claims.

What is claimed is:

1. A method of receiving funds via a linked deposit-only account identifier, comprising:
generating a deposit-account only identifier;
linking at least one user-selectable transaction account to the deposit-only account identifier;
configuring the at least one user-selectable transaction account to receive funds via the deposit-only account identifier.

2. The method of claim 1, wherein the at least one user-selectable transaction account comprises an account maintained by a banking institution.

3. The method of claim 1, further comprising transmitting the received funds to a suspense account when no valid user-selectable transaction account is available.

4. The method of claim 1, further comprising transacting funds in the at least one user-selectable transaction account to or from a third party.

5. The method of claim 1, wherein at least one of a geographic location of the user-selectable transaction account, a currency denomination of the user-selectable transaction account, an account owner of the user-selectable transaction account, and an available funds amount of the user-selectable transaction account are inaccessible to an entity transferring funds using the deposit-only account identifier.

6. The method of claim 1, wherein receiving the funds occurs across international borders.

7. The method of claim 1, wherein the at least one user-selectable transaction account comprises a plurality of user-selectable transaction accounts.

8. The method of claim 7, further comprising distributing the received funds to at least one of the plurality of user-selectable transaction accounts based on user-selected criteria.

9. A system for receiving funds via a linked deposit-only account identifier, comprising:
an interface to an electronic payment network; and
a processor, communicating with the interface to the electronic payment network, the processor being configured to
link at least one user-selectable transaction account to a deposit-only account identifier, and
configure the at least one transaction account to receive funds via the deposit-only account identifier.

10. The system of claim 9, wherein the at least one user-selectable transaction account comprises an account maintained by a banking institution.

11. The system of claim 9, wherein the processor is further configured to transmit the received funds to a suspense account when no valid user-selectable transaction account is available.

12. The system of claim 9, wherein the processor is further configured to transact funds in the at least one user-selected transaction account to or from a third party.

13. The system of claim 9, wherein at least one of a geographic location of the user-selectable transaction account, a currency denomination of the user-selectable transaction account, an account owner of the user-selectable transaction account, and an available funds amount of the user-selectable transaction account are inaccessible to an entity transferring funds using the deposit-only account identifier.

14. The system of claim 9, wherein receiving the funds occurs across international borders.

15. The system of claim 9, wherein the at least one user-selectable transaction account comprises a plurality of user-selectable transaction accounts.

16. The system of claim 15, wherein the processor is further configured to distribute the received funds to at least one of the plurality of user-selectable transaction accounts based on user-selected criteria.

17. A deposit-only account identifier, the deposit-only account identifier being generated by a method comprising:
generating a deposit-only account identifier;
linking at least one user-selectable transaction account to the deposit-only account identifier; and
configuring the at least one transaction account to receive funds via the deposit-only account identifier.

18. The deposit-only account identifier of claim 17, wherein the at least one user-selectable transaction account comprises an account maintained by a banking institution.

19. The deposit-only account identifier of claim 17, wherein the method further comprises transmitting the received funds to a suspense account when no valid user-selectable transaction account is available.

20. The deposit-only account identifier of claim 17, wherein at least one of a geographic location of the user-selectable transaction account, a currency denomination of the user-selectable transaction account, an account owner of the user-selectable transaction account, and an available funds amount of the user-selectable transaction account are inaccessible to an entity transferring funds using the deposit-only account identifier.
